(19) United States
(12) Patent Application Publication
(10) Pub. No.: US 2006/0071357 A1
(43) Pub. Date: Apr. 6, 2006

(54) Method and apparatus for liquid microencapsulation with polymers using ultrasonic atomization

(76) Inventors: Laurent G. Pilon, Los Angeles, CA (US); Halil Berberoglu, Los Angeles, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/238,089

(22) Filed: Sep. 27, 2005

Related U.S. Application Data
(60) Provisional application No. 60/613,879, filed on Sep. 27, 2004.

(51) Int. Cl. B29C 39/10

(52) U.S. Cl. 264/4

(57) ABSTRACT

An apparatus and method for encapsulating a liquid or suspension within a polymeric shell to form a microcapsule of a selected size ranging from approximately 0.1 μm to 1000 μm in diameter. The apparatus preferably has a laminar flow of air through a channel and ultrasonic atomizer with the head oriented at approximately ninety degrees from the laminar flow. Emulsions, liquids or thin films of core and shell materials are atomized and the formed microcapsules are exposed to ultraviolet light or additionally infrared light to cure the polymer shell and then are collected. A variety of capsule morphologies can be created by the choice of materials and process conditions to achieve desired controlled or programmed release kinetics. Surface functionalization of the outer shell of the microcapsules capsules can also be achieved to facilitate targeted delivery.

### CROSS-REFERENCE TO RELATED APPLICATIONS

This application claims priority from U.S. provisional application Ser. No. 60/613,879 filed on Sep. 27, 2004, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to liquid substrate encapsulation for metered delivery systems, and more particularly, to an apparatus and method for microencapsulation of a substrate with a polymer shell using ultrasonic atomization.

2. Description of Related Art

Microencapsulation is the process of encasing a core of small solid particles, droplets of liquid or gas bubbles within a continuous shell or capsule. The resulting microcapsules are generally spherical in shape with diameters ranging from a few microns to a few millimeters.

The liquid core material of a microcapsule may be a solution, a suspension, and emulsion or a mixture of substances. A wide variety of core materials have been encapsulated with many different physical and chemical properties such as oils and emollients, fragrances, waxes, pheromones, insecticides, herbicides, fertilizers, catalysts, solvents, adhesives, dyes, inks, flavors, proteins, medicines and other biological preparations.

The outer shell of the microcapsule may be composed of a variety of coatings such as waxes, cellulose, polyethylene glycol, gelatin, organic polymers, resins, inorganic oxides, hydrocolloids, metals, proteins, starches or fats. The shell may be permeable, semi-permeable or impermeable to water, solvents or large molecules and may be biodegradable or persistent in the environment.

The core material contained in a microcapsule may be released to the surroundings in predictable quantities over time or may be deliberately released entirely through rupture of the microcapsules via applied pressure, shear forces, osmotic changes, dissolution or melting of the outer shell depending on the application.

The small size and physical characteristics of microcapsules allow for their use in a wide variety of applications. Core materials may be volatile, reactive, sensitive to oxidation or chemically incompatible with the surroundings during delivery. The shell material in a microcapsule can be selected to protect the core material from degradation in the environment, evaporation, and chemical incompatibility and may extend the active life of a core material in particular applications.

Core materials may also be toxic to the environment or to the person handling or administering the product. Consequently, microencapsulation may be used for stabilizing toxic materials and for safety. For example, the core material may be permanently encapsulated and never released thereby rendering the core material inert and easily handled, stored or destroyed.

One significant benefit of the use of microcapsules is the ability to control the delivery of an active ingredient to targeted areas. This can be achieved, in part, by the functionalization of the shell. Controlled delivery permits the administration of a small dose sufficient to be effective while avoiding overexposure of the whole system to otherwise toxic amounts of the core material. Furthermore, the targeted area receives a sufficient dose of active core components with a greatly reduced loss of activity when using chemically or physically sensitive core materials. For example, pesticides or fertilizers can be administered in smaller amounts and the release of the core material can be timed and controlled. Losses due to exposure to the sun and the environment are minimized. Accordingly, through encapsulation, controlled release of active ingredients may be realized which provides an optimal dosage and maximized cost effectiveness as well as reduced worker exposure.

Controlled release rates and locations are also the basis of many drug delivery systems using microcapsules. Controlled release can be achieved upon disruption of the shell material (e.g., its transport properties, solubility, permeability, thickness) via mechanical stress, ultrasound, pH, osmotic force, temperature, or enzymatic activity just to name a few. The controlled release rate of material from degrading microcapsules allows for the administration of lower doses of a drug to have the same pharmacological effect since the drug can be protected while entering the system and the concentration can be maintained in the proper location in the body over a longer period of time. This can reduce the number of doses as well as lower the risk of significant side effects.

Microparticles have been classified according to their physical characteristics into three basic categories: mono-cored, poly-cored and matrix types. Mono-cored microcapsules have a single hollow chamber within the capsule. The poly-core microcapsules have a number of different sized chambers within the shell. The matrix type microparticle has the active ingredients integrated within the matrix of the shell material. The morphology of the internal structure of a microparticle depends largely on the selected shell materials and the microencapsulation methods that are employed.

A number of microencapsulation methods and techniques have been developed in the art that may be generally grouped into three main classes. The most common method of microencapsulation is solvent extraction of an aqueous or organic phase. This technique basically mixes the desired core material for encapsulation with a polymer solution in a first organic solvent. The mixture is then combined with a second immiscible solvent, which is later evaporated off as part of the process. Solvent extraction method is just the curing part of the process, size and size distribution will depend on the particular mechanism of capsule creation.

A second class of microencapsulation methods is “spray” drying. In this method, an aqueous phase containing the core material in solution or suspension is prepared and combined with an organic phase containing a polymer to create a water/oil type of emulsion. This process is typically used in the food industry. The entrapped ingredient is usually a fat, oil, or flavor compound, and the coating is usually a carbohydrate. An emulsion is formed between the core and coating, and the emulsion is sprayed under pressure and dried in a hot air drying chamber.

A third class of encapsulation methods includes the emulsion/phase separation techniques. Emulsion methods typically begin with an aqueous solution of the desired core material dispersed into an immiscible organic phase including the polymer to form an emulsion. A coacervation agent, such as vegetable or mineral oil, is then added to the emulsion causing the formation of the microcapsules. Large amounts of process materials are used with this class methods because the formation of the capsules is dependent on the quantity of solvent, polymer and coacervation agent that is used. Another disadvantage of emulsion methods is that the newly formed capsules tend to adhere to each other.

Other physical methods of microencapsulation include spray chilling, rotary disk atomization, fluid bed coating, stationary nozzle co-extrusion and submerged nozzle co-extrusion.

The high cost of microencapsulation may limit its use in certain beneficial applications. One significant contributor to the costs associated with microencapsulation is the number of steps involved in the process. The cost of the solvents, coacervation agents and shell material that is selected may also cause the cost of microencapsulation to rise.

The complexity of the microencapsulation method may also contribute to significant losses and increased costs of production. For example, some methods require washing and drying of the capsules to remove solvents or other processing reactants or contaminants increasing the complexity of the process and resulting in lower yields. In addition, high temperatures and pressures that are required with some encapsulation methods can result in yield losses and inactivation of the chemical or biological activity of the core materials. Encapsulation may be affected by factors such as the hydrophobicity, molecular weight, chemical stability, and thermal stability of the core material limiting the available methods or core materials that may be microencapsulated. In addition, some applications require the microcapsules to be monodispersed while some processes produce only polydispersed microcapsules.

Accordingly, there is a need for improved methods of microencapsulation that have a reduced number of steps, precise control over the capsule parameters, elimination of high temperature and pressure as process steps, and have accurate and reliable control over the size of the microcapsules produced. The present invention satisfies these needs as well as others, and generally overcomes the deficiencies found in existing equipment and methods in the art.

### SUMMARY OF THE INVENTION

The present invention is an implemented method and associated apparatus for producing microcapsules containing a liquid substrate core and preferably having a polymer shell and ranging in size from approximately 0.1 μm to approximately 1000 μm in diameter.

According to one aspect of the invention, an apparatus is provided that is preferably configured to create a microcapsule with a single chambered core and a polymeric shell that is curable with ultraviolet or infrared light. In one embodiment of the invention, the apparatus comprises a generally linear housing with a source of carrier air or gas providing a laminar flow through the housing. An ultrasonic horn and controlled multi-liquid dispenser is coupled to the housing such droplets produced from the ultrasonic horn are carried within the laminar flow. In one embodiment, an ultraviolet light source is provided that exposes the droplets to ultraviolet light thereby curing the polymer shell of the droplets forming a shell as they pass through the length of the housing in the flow of air or gas. In a further embodiment, an infrared light source is provided alone or in conjunction with the ultra violet light source to dry the liquid contents of the core of the particles or to heat cure the shell.

According to another aspect of the invention, means for electrostatically charging the walls and microcapsules after formation to preclude droplet coalescence, minimize surface deposition on the walls of the housing or facilitate collection of the cured capsules.

According to another aspect of the invention, the cured capsules that exit the chamber can be collected without the use of collection baths or hardening baths or the need for drying schemes. In one embodiment, microcapsules are collected by electrostatic collection, electrostatic filtering, guided airflow with a mechanical filter and gravity collection.

According to a further aspect of the invention, a source of atomized droplets of shell polymer and core liquid substrate material is alternatively provided by the deposition of thin films of shell material on one or more layers of core materials that are then vibrated at ultrasonic frequencies to eject droplets of encapsulated substrate.

Another source of atomized encapsulated droplets of core and shell material is with the use of ultrasonic-modulated two fluid (UMTF) atomization methods. In one embodiment, a multi port ultrasonically vibrating nozzle with an airflow jacket is used to create microcapsules. In this embodiment, one or more core fluids are co-extruded with shell material to create microcapsules.

According to another aspect of the invention, an apparatus for microencapsulating liquids, solids or gases within a shell is provided that has a housing with an interior chamber configured for the directional flow of fluid through said chamber; a source of a laminar flow of a fluid through the interior of said chamber; an ultrasonic generator coupled to the housing with a vibrating surface disposed within the interior of said chamber and at an angle to the laminar flow of said fluid through said interior chamber and a source of an encapsulant and a core substrate configured to provide the encapsulant and core substrate to said vibrating surface of the ultrasonic generator; and means for curing microcapsules produced by the ultrasonic generator.

According to a further aspect of the invention, an apparatus for producing microcapsules is provided with a tubular housing; a source of a laminar flow of gas through the interior of said tubular housing; means for atomizing fluids coupled to said housing oriented at an angle to the laminar flow of said gas through said tubular housing; and means for curing microcapsules entrained is the laminar gas flow.

Another aspect of the invention is to provide a method for manufacturing microcapsules including atomizing a mixture of an uncured shell composition and a substrate using ultrasonic waves within a fluid flow that is at an angle to the ultrasonic waves to produce microcapsules and then curing said microcapsules within the fluid flow.

It can be seen that the choice of material properties can give single cored core-shell, multi cored core-shell or a matrix type, where the active ingredients are uniformly dispersed in the encapsulant microparticles. The release kinetics of the capsules can be tuned by the capsule morphology, the degree of polymerization, and type of core and/or shell material used.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a schematic of one embodiment of an apparatus according to the present invention using ultra violet light exposure.

FIG. 2 is a schematic of one embodiment of an apparatus according to the present invention using ultra violet light and infra red light exposures.

FIG. 3(a) through FIG. 3(c) is a schematic representation of a thin film on an ultrasonic head of an alternative embodiment according to the invention.

FIG. 4 is one embodiment of an ultrasonic nozzle with an airflow jacket for encapsulation according to the present invention.

### DETAILED DESCRIPTION OF THE INVENTION

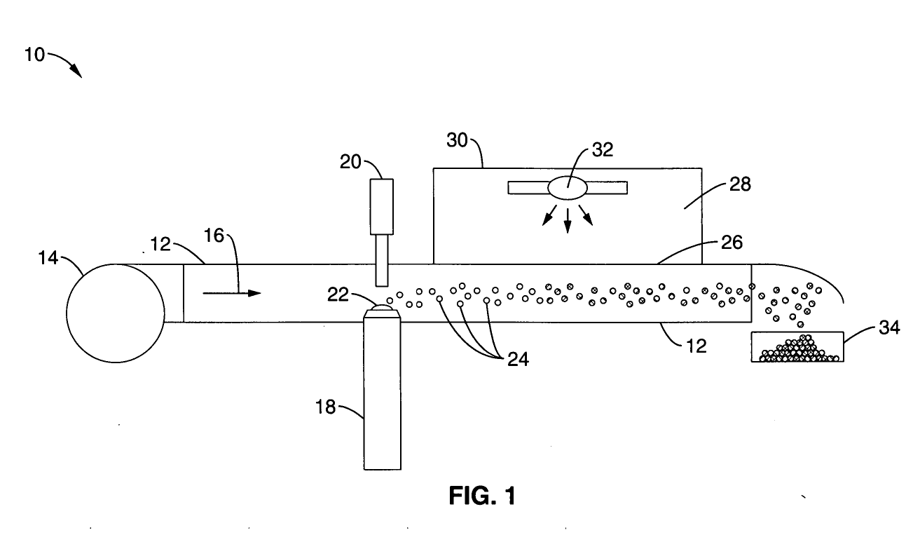

Referring more specifically to the drawings, for illustrative purposes the present invention is embodied in the apparatus generally shown in FIG. 1 through FIG. 4. It will be appreciated that the apparatus may vary as to configuration and as to details of the parts, and that the method may vary as to the specific steps and sequence, without departing from the basic concepts of the invention as disclosed herein.

The present invention provides an apparatus and method for producing a microcapsule that is generally spherical in shape, has a monocore-shell structure and can have a tunable size from approximately 0.1 μm to 1000 μm in diameter. The invention preferably utilizes heat or UV curable polymers as the shell material. The ideal polymers for selection will be low viscosity polymers, with low to negligible miscibility in water and fast cure rates. The UV curable polymers preferably contain fast acting photo-initiators and sensitizers to facilitate the curing process.

The preferred core material is liquid water or water based where the active components are either (i) dissolved in water, or (ii) in suspension in water, or (iii) in an oil phase which is emulsified in water. It is preferred that the core material has low miscibility in the shell material and that it be more cohesive than the shell material.

Turning now to FIG. 1, a schematic of one embodiment of an apparatus 10 of the invention is generally shown. In this embodiment, the apparatus 10 has a generally tubular housing 12 that is coupled to a source of air or gas flow 14 such as a fan or a pressurized tank. The tubular housing 12 and air source 14 are sized to permit the creation of a laminar flow 16 of gas through the housing 12 at controllable flow rates. Laminar airflow is defined as the unidirectional flow of gas or liquid through the entire cross-section of the housing 12 with a steady velocity and approximately parallel streamlines. The flow is preferably free of fluctuations (turbulence) that occur when the dimensionless ratio of the inertial to viscous forces (Reynolds Number) in the housing 12 is less than approximately 2000. Although a laminar flow of gas is preferred, it will be understood that a liquid carrier that is transparent to ultraviolet or infrared light may also be used. However, the use of a liquid carrier instead of gas will require liquid filtration and drying steps that are eliminated with the use of laminar gas flows.

The head of ultrasonic horn 18 is mounted in the housing 12 so that it resides in the laminar gas flow in the interior of the housing 12. Although it is preferred that the horn 18 be perpendicular to the direction of the laminar flow, it need not be exactly ninety degrees. In addition, even though one ultrasonic horn 18 is shown in FIG. 1, it will be understood that several ultrasonic horns 18 can be disposed in the interior of the housing 12.

A controlled liquid dispenser 20 feeds drops or provides a continuous flow of material on to the surface of the head 22 of the ultrasonic atomizer 18 to form loaded uncured microcapsules 24. In one embodiment, a large droplet of core and shell material is extruded from a co-axial nozzle on the surface of head 22 of the ultrasonic atomizer 18. Another way to achieve the encapsulation with this method is to continuously maintain a multi layer thin film of liquids on the surface of the vibrating surface. The dispenser can be a plurality of thin tubes (inner diameters ˜0.5 mm) stacked on top of each other in another embodiment.

In one embodiment, the procedure begins with the creation of a water/oil (W/O) emulsion using water and/or water soluble components and UV curable monomer solution with an appropriate photo-initiator. The emulsion can be obtained via standard techniques such as shaking, stirring, spinning, and ultrasonication. The formed emulsion is then fed from dispenser 20 to the surface of an ultrasonically vibrating surface 22 of the atomizer 18. When the vibration amplitude is high enough the emulsion atomizes into small droplets. These droplets assume a core-shell structure with water at the core and the polymer forming the shell, due to the process of adhesion.

The core and/or shell material can also be a pre-made emulsion. This gives flexibility in tuning the release characteristics of the capsules. In this way four combinations are possible: (i) core single phase—shell single phase, (ii) core emulsion—shell single phase, (iii) core single phase—shell emulsion and (iv) core emulsion—shell emulsion.

Utilization of an emulsion in the core can also facilitate encapsulation of non-water soluble active ingredients. First the oil-soluble ingredients are dissolved in a selected oil and a water-oil emulsion is made thereafter. Finally the prepared oil-water emulsion is atomized together with the shell material and the capsules are formed. Accordingly, it is possible to encapsulate both water-soluble and oil-soluble active core ingredients in an appropriate emulsion.

It will also be seen that any type of UV curable or heat curable polymer that has low solubility in water (preferably immiscible) is particularly appropriate for the apparatus and method. Alternatively, a dissolved polymer in a solvent is appropriate where polymer hardening is achieved by solvent evaporation. The solvent will evaporate out of the capsule shell and into the laminar air stream. For drug encapsulation type applications, these can be bio-compatible and bio-degradable polymers. The UV curable polymers need the addition of fast acting photo-sensitizers and photo-initiators that absorb UV light and start the UV curing process.

There are generally two techniques that may be used for atomizing liquids with ultrasonic excitation. The first way is to atomize a liquid over an ultrasonically vibrating surface and the second way is to pass the liquid across a standing ultrasonic wave. Although the mechanism of atomization is not well understood, it is believed that cavitation or capillary waves are responsible.

The effects of excitation frequency and liquid properties (density, viscosity, surface tension) on the atomization of single-phase liquid have been well studied and documented in the literature. The relation between atomized droplet diameter and the excitation frequency, liquid properties and is given as:

$$d = 0.73 {( \frac{γ}{ρ {f}^{2} } )}^{1 / 3}$$

where γ is the interfacial surface tension of the liquid in air, ρ is the density of the liquid, and f is the excitation frequency.

Overall, it has been shown that some of the key parameters affecting the atomization of a liquid from a vibrating surface are excitation frequency, excitation amplitude, liquid properties, pulsed versus continuous excitation and the amount of liquid on the horn tip or head. The loaded capsules 24 are carried with laminar airflow 16 to the UV curing chamber section of housing 12 where enough UV radiation is provided from the UV light source 28 to cure the polymeric shell without affecting the core material. In the embodiment shown schematically in FIG. 1, the ultra violet light source 18 comprises a reflecting housing 30 with a UV lamp 32.

The cured capsules are preferably collected in the collection chamber 34 using either electrostatic attraction or an air filter. The transportation of the capsules in the air flow channel of housing 12 can also be assisted by applying a similar electric charge to the droplets and the walls of the channel of the housing to prevent both droplet coalescence and deposition on the walls of the flow channel.

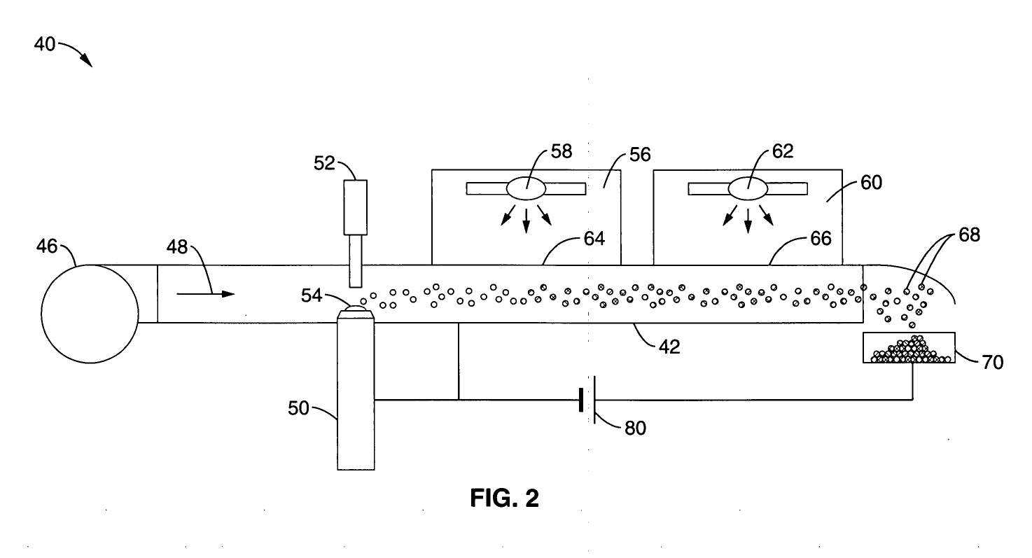

Turning now to FIG. 2, an alternative embodiment of the apparatus of the invention is schematically shown with the additional features of an infrared lamp with exposure chamber and electrostatic charging. The apparatus 40 shown in FIG. 2 is comprised of a housing 42 with a central channel 44 and a source of gas or air 46 permitting a laminar air flow 48 through channel 44 with a controllable low speed air flow. The selection of airflow rate depends on the curing speed of the polymer, length of the UV curing channel 44, and degree of polymer cross-linking that is desired.

Perpendicular to the laminar airflow 48 is the ultrasonic atomizer 50 with an ultrasonically vibrating surface 54. A liquid dispenser 52 is also provided which can dispense multiple liquids at controllable rates and amounts. The housing 42 also has ultraviolet (UV) curing and infrared (IR) exposure sections. Enclosure 56 attached to housing 42 has an IR lamp 58 and enclosure 60 has a UV lamp 62. The UV cure section of housing 42 has a UV transparent window 64 so that the UV source 62 can shine into the housing 42 from chamber 60.

In order to maximize the UV energy in this section, the rest of the walls may be covered or coated with a UV reflecting material such as aluminum foil. Likewise, the IR exposure section of housing 42 has an IR transparent window 66 and, similar to the UV cure section, has its enclosure 56 walls covered with IR reflecting material such as aluminum foil. The reflectivity of aluminum has been shown to be normally greater than 92% for wavelengths between 100 and 500 nm (this is UV through part of visible spectrum) and is greater than 96% for wavelengths greater than 1500 nm (IR). Furthermore, the windows 64,66 used for letting the IR or UV light from their respective chambers into the housing 42 may incorporate narrow band, or high pass filters to eliminate excessive infrared radiation from entering the chamber 42. However, heat curing can be enhanced by incorporating micro and/or nanoparticles in the shell and/or in the core, which are strongly absorbing in the UV or infrared part of the spectrum corresponding to the UV or IR light source.

The collection of the capsules 68 can be by electrostatic collection, electrostatic filtering, guided air flow with an appropriate filter or by just reducing the air flow velocity down the flow channel and letting gravity pull the capsules down. The microcapsules 68 are collected in a bin 70 or could be directly packaged. One beneficial aspect of the apparatus is the elimination of collection baths, hardening baths that are commonly used in encapsulation technologies. Another added advantage of eliminating the collection bath is that some droplets, especially small ones, once they hit the surface of a liquid pool can spread on the surface and hence loose their core-shell structure or their spherical shape. This depends on the momentum of the droplets and the interfacial tension of the pool liquid and the shell liquid. These additional manufacturing steps and problems are avoided with the present invention.

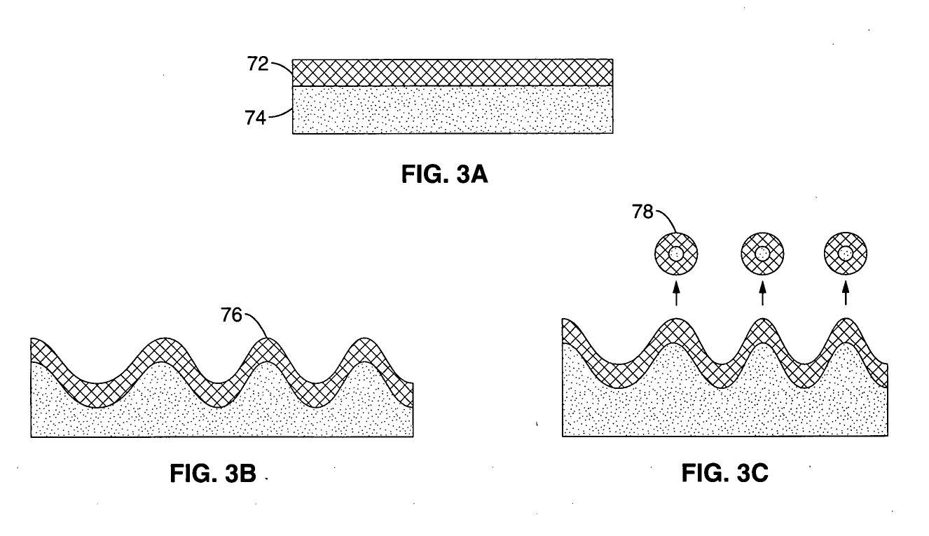

Referring also to FIG. 3(a) through FIG. 3(c), an alternative method for generating microcapsules within the laminar flow 48 of housing 42 is described. In this technique the core and shell materials need not be made into emulsion form. Instead a thin film 72 of shell material such as a monomer solution is spread over an aqueous layer 74 of core material as shown in FIG. 3(a) on the head of the ultrasonic head 54. Single layers of shell and core material are shown as an illustration. However, this process can be extended to more than two liquids by choosing liquids of appropriate density that are immiscible in each other and have the right surface tensions.

The spreading of a liquid A over an other liquid B in air is dictated by the work of spreading Wₛₚᵣ which is defined as, Wₛₚᵣ=γ^{B-Air}−γ^{A-Air}−γ^{AB}, where γ^{B-Air}, γ^{A-Air} and γ^{A-B} are the interfacial tensions of liquid B and air, liquid A and air, and liquid A and liquid B, respectively. As long as Wₛₚᵣ is positive, liquid A will spread over liquid B. In the event the two immiscible liquid solutions cannot spread over each other, appropriate surfactants can be added to the liquids to adjust the relative interfacial tensions. This will ensure that the work of spreading is positive thus making spreading spontaneous and energetically favorable.

As the liquid is vibrated at ultrasonic frequencies, capillary waves will be produced on the surface as seen in FIG. 3(b). Once a capillary waves 76 reach a critical amplitude, related to the ultrasonic excitation power, the liquid will be atomized in such a way that each droplet will contain both the aqueous core material 74 and the monomer solution 72. Through the process of adhesion, the monomer 72 will spread over the aqueous phase creating the core-shell structure 78 as seen in FIG. 3(c). The peaks of the waves are exposed to the laminar flow of gas at approximately a ninety-degree angle during atomization and shear type forces facilitating the separation and formation of the droplets and the removal of the formed droplets away from the vibrating films through the interior of housing 42.

It will be seen that the overall diameter, core to shell ratio and morphology of the microcapsules can be manipulated. The overall size of the capsule depends on the frequency of excitation and the viscosity, density, and surface tension of the involved liquids. The core to shell ratio, on the other hand, depends on the thickness of each liquid layer.

In addition, it is possible to use an emulsion or a suspension in place of the water phase 74 and create an emulsion or a suspension core. In this way, the active components that are to be encapsulated in the core-shell capsule need not be strictly water soluble. In addition, numerous active components can be encapsulated in the same capsule without being mixed previously. This adds value to the encapsulation process in situations where premixing of components is not desirable such as two parts of an epoxy adhesive for example. Therefore, the active components do not mix and react until the capsule is disrupted. This idea can find application in smart composites where micro encapsulated two-part epoxy can be embedded in structural components and upon fracture capsules release adhesives and provide self-healing.

Referring still to FIG. 2, the typical process for producing microcapsules begins with the dispensing of a multi-layer liquid film on the ultrasound head surface 54. This liquid film is composed of multiple immiscible liquids. In the simplest case there are only two layers: (i) the water phase containing the active components and (ii) UV or IR curable polymer phase.

When ultrasonic excitation of a given frequency and above a certain power level is applied the liquid film is atomized into small droplets 68. The overall size of the droplets depends on the frequency of excitation and on the effective viscosity, density and surface tension of the liquid film. Each droplet contains a given fraction of the water and polymer phases determined by the relative thicknesses of each layer. Each droplet assumes a spherical shape (due to surface energy minimization) and the polymer phase surrounds the water phase due to the work of adhesion. In the case of multiple polymer layers each layer spreads over another, creating a multi-layer polymer coating, with each polymer having a particular unique functionality (for example different diffusion characteristics, water absorption/expansion property, dissolution or degradation property etc.).

The created capsules 68 are entrained in the laminar airflow 48 and are carried to the UV curing and IR exposure sections of housing 42. In the UV curing section, the polymer absorbs the UV radiation from source 62 coming through the UV transparent window 66 and curing is initiated. The degree or extent of the polymerization of the polymer can be controlled by manipulating the UV intensity, the length of the exposure section of housing 42, the speed of airflow 48 in the channel and the curing properties of the polymer.

In addition, a particular surface functionalization of the capsule surface can be achieved by the selection of the particular gas flowing in the flow channel of housing 42 or by coating the capsule after the shell has been cured via spraying or chemical vapor deposition. Functionalization of the outer shell of the capsule can take several forms depending on the intended application of the core material. For example, functionalization can be the application of a coating that can be a specific type of surfactant, organic molecule or antibody, which functionalizes the surface of the capsule for targeted delivery. Surface functionalization of the shell of the capsule may also be achieved by chemical treatments of the shell or adding on chemical compounds on the surface to improve the durability and target delivery. In one embodiment, surface functionalization of the outer shell of the capsules can take place while they are traveling in the fluid flow by chemicals present in the ambient laminar flow. Some of the chemicals may be activated by UV or IR radiation allowing selective control over functionalization. Thus, by the time the capsules come out of the flow channel, they have the desired physical and chemical characteristics for achieving targeted and controlled/programmed release characteristics.

In another embodiment, the cured capsules are encapsulated and used as the core of one or more outer shells using conventional techniques. A second shell can influence the slow release characteristics of the capsule as well as the degradation characteristics in the intended application environment of the microcapsule. Accordingly, a second shell will allow the use of an inner shell that is not durable in the environment but particularly suited for certain reactive core materials. A broader range of core liquids may be encapsulated and used in many different applications. Greater control can be exercised over the morphology of the capsules and their release characteristics.

A capsule within a capsule structure may also be created with the method. For example, the core material of the central capsule may be reactive with a second material that is encapsulated in a larger capsule with the central capsule. Rupture of the two capsules permit the two reactive materials to combine.

If the polymer being used is not heat curable, the IR exposure section may not be necessary. However, this exposure section can be used to provide heat energy to the capsules (before or after curing) so as to evaporate the water content of the core leaving dried active components inside the polymeric shell. For example, with the apparatus it is possible to make a “burst-release” type capsule that will hydrate and release the active contents all at once. This can be achieved in two ways: (i) using a capsule with a swelling core and rigid shell, and (ii) using a capsule with double shell (one swelling and one rigid). In creating the “burst-release” capsules, the atomized capsules are heat treated first to get rid of the water content and then UV cured to become rigid.

Finally, the cured and processed capsules 68 are collected at the end of the channel either by direct deposition into containers 70 using electrostatics or by filtration. Yield losses and coalescence of particles may be minimized by electrostatic charging 80 that includes charging the generated particles 68 and the walls of the flow channel of the housing 42. The elimination of collection fluid or hardening baths used in the art reduces manufacturing time and costs because filtering, washing and drying steps are unnecessary.

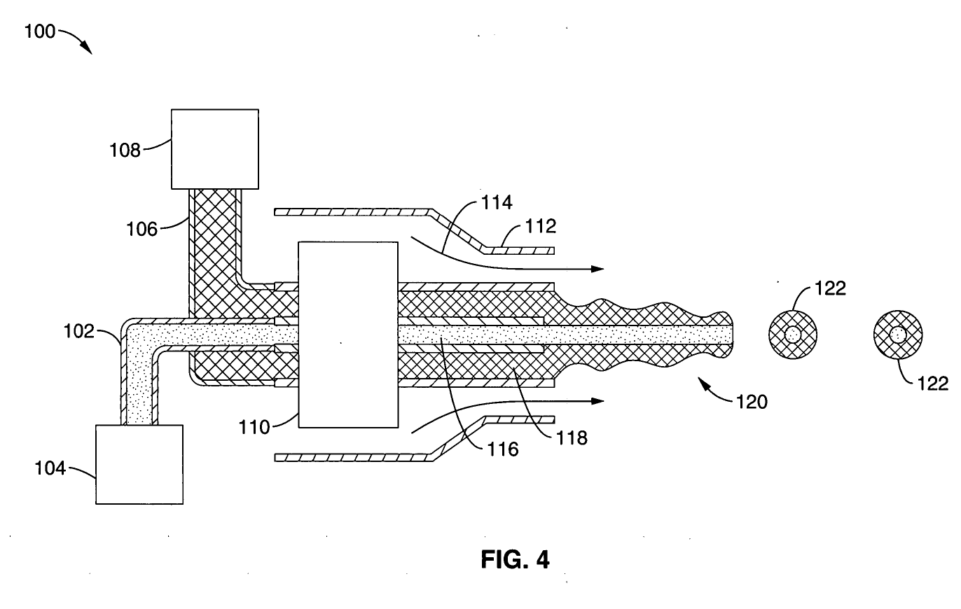

Turning now to FIG. 4, an alternative embodiment of an apparatus for the formation and atomization of a multi layer liquid in FIG. 2 or ultrasonic head in FIG. 1 is schematically shown. An ultrasonic modulated two-fluid atomization nozzle 100 is shown to illustrate the encapsulation of a single core fluid with a shell. Although a nozzle dispensing two fluids is shown, it will be understood that the nozzle could co-extrude multiple fluid (or emulsion) streams.

In the embodiment shown in FIG. 4, the nozzle 100 has a central inner duct 102 attached to a source of core material 104 and a larger diameter outer duct 106 surrounding the inner duct 102 attached to a source of shell material 108. The inner duct 102 and outer duct 106 are coupled with an ultrasonic transducer 110. The ultrasonic transducer 110 and inner duct 102 and outer duct 104 are preferably disposed within an airflow jacket or housing 112. Air or some other gas 114 is directed around transducer 110 and ducts 102,106 and around the stream of extruded material from the ducts. Core fluid 116 is co-extruded with shell fluid 118 to form a jet 120 ultimately forming capsules 122.

This method uses an ultrasonically vibrating nozzle 100 to dispense a particular fluid jet 120 and amplify the capillary waves resulting from the ultrasonic vibrations by flowing gas 114 around the jet 120. This process achieves tighter droplet diameter distribution and utilizes less ultrasonic power, two orders of magnitude less, which can be critical to prevent material degradation in some applications. If the ultrasonic power levels required are low enough, then cells and bacteria may also be encapsulated utilizing the method. Therefore, the process has higher product quality and consumes less power.

It is also anticipated that a co-axial nozzle with two, three or more co-axial liquid extrusion capabilities can be used in the apparatus shown in FIG. 1 or FIG. 2 so that the capsules 122 are exposed to the laminar flow of air or gas within a curing channel.

The present invention may be more particularly described in the following examples that are intended for illustrative purposes only, since numerous modifications, adaptations and variations to the apparatus and methods will be apparent to those skilled in the art.

### EXAMPLE 1

To demonstrate the viability of the methods and apparatus shown schematically in FIG. 1, a test apparatus was fabricated with a tubular flow channel approximately 18 inches long with a 2×2 inches square cross section made of acrylic plexiglass. A 6″×2″ UV transparent Fotodyne's UviClear top window was added in the region of the continuous UV curing lamp mainly emitting UV light between 260 nm and 460 nm and consuming 400 Watts of electrical power. The window transmits 85% of the UV light at 312 nm. To enhance the illumination inside the channel, the bottom and side walls were covered with highly reflecting aluminum foil. The flow rate in the channel was achieved using a variable controlled transformer (variac) to regulate the air fan. The speed of airflow in the channel was calibrated for the voltage settings of the variac using an anemometer. The flow rate used during the experiments was 2.4 ms⁻¹. The horn ultrasound was a Vibra Cell Model V1A of Sonics and Materials.

The UV curable polymer used in the experiment was Sartomer's SR 494 four functional monomer. This monomer was chosen because of its low viscosity and relatively high functionality. The monomer solution had 5% by weight Sartomer's SR 1120, a photoinitiator with absorption band in 250-350 nm range. Photoinitiator was added and stirred with magnetic stirrer in the dark at room temperature until the photoinitiator was completely dissolved. The aqueous phase used was tap water colored with ink to increase the visibility of water phase under optical microscope. The volumetric concentrations were 20% Water and 80% monomer solution.

The excitation frequency of the equipment was fixed at 20 kHz. It could provide 0-600 W ultrasonic power through a horn of flat tip with 0.5″ cross sectional diameter. In the setup, the ultrasonic horn was inserted into the channel from the bottom of the channel so that the flat surface of the horn tip was facing upwards. The liquid mixture to be atomized was applied on the horn tip using a liquid dispenser, a 3 mL syringe in this case, from the top of the channel. The UV source was a 400 W Hg-arc lamp irradiating an area of roughly 6″×3″. The generated and cured particles were collected at the exit of the channel by directing the flow on a plastic recovery dish.

Analysis of the resulting microcapsules by microscopy revealed single chambered spherical microcapsules approximately 50 μm in diameter and had a loading capacity of over 50% by volume.

Surface functionalization of the capsules can be achieved by having an appropriate gas in the airflow channel and providing the activation energy to the surface of the microcapsules by UV or IR radiation. In addition, to enhance the crosslinking of the polymeric shell, the carrier gas can be chosen to be an inert gas such as argon or nitrogen. Thus, the free radicals generated by the photoinitiators are not consumed by oxygen molecules but rather used in the process of crosslinking.

### EXAMPLE 2

Another non-limiting example of apparatus and method of the invention was tested using a multi-port injector as a source of microcapsules. The injector head was suspended at the top of a transparent housing with an ultraviolet light source directed into the interior. A collector was at the opposite end of the housing from the injector head and water was used as a trap. Microcapsules formed at the injector head would fall under the forces of gravity through the UV light to the collector.

In this example, the monomer Propoxylated(2) Neopentyl Glycol Diacrylate (SR-9003) from Sartomer, PA and the photo-initiator Benzil Dimethyl Ketal (Sarcure SR-1120) from Sartomer, PA were used. The monomer solution was prepared by adding 3% by weight photo-initiator to the monomer. The core material that was used was tap water and a surfactant, Tween-80. The water-surfactant solution was prepared by adding 10 ml of Tween-80 to 100 ml of water. A few drops of red ink were added to the water-surfactant solution to color it for visual inspection purposes.

The water that was encapsulated, in this example, contained an ample amount of surfactant molecules, which orient themselves with hydrophilic heads oriented in the water phase and hydrophobic tails in the monomer phase stabilizing the interface of the two phases. In this case, no surfactant was added to the monomer since there was no need for it. However, appropriate chemicals or surfactants can be added to the monomer solution to functionalize the surface of the polymeric shell. In addition, chemicals present in the collection water can bring about the surface functionalization.

Once the solutions were prepared, the polymer and the core water core material were loaded to the respective injection ports of the multi-port injector head. The core material was loaded into the reservoir associated with the central axial channel of the head and the polymer solution was loaded into the reservoir associated with the peripheral channel of the head as schematically shown in FIG. 4.

The injection levels of the material entering the two ports may be adjusted so that a core and a shell structure may be ultimately obtained encapsulating the water in the core. It can be seen that injection of the two materials increases the overall size and weight of the emerging shell-core structure and causes the gravity to break down the monomer continuum and the released core and shell structure assumes a spherical shape.

After release, the outer shells of the formed spheres were cured as they fell in the air through the curing zone of ultraviolet light. The UV lamp that was used was Cure Zone HO2 with 400 W Hg-arc bulb. Cured hard-shelled microcapsules were collected at the bottom of the beaker. The selection of the overall length of the housing was based on the chosen polymer characteristics and the time necessary to cure the microcapsules. The size of the housing was also selected to provide a sufficient exposure time within a finite falling distance, and also to provide a heat sink to absorb excessive heat during cooling.

The apparatus and methods disclosed herein provide a number of benefits and advantages over the art. The invention improves on the current methods and materials that sacrifice either capsule morphology controllability or ease in processing or both. The core-shell encapsulation not only fully protects the active ingredients but also allows for higher loading capacities. The use of UV-curable polymers allows for reproducibility in large scale, mechanical durability, and controllability in terms of its mass transfer characteristics rarely achieved in common materials presently used for encapsulation.

The apparatus and methods of the invention reduce the number of steps in the production of microcapsules. For example, the process does not require additional harvesting steps and can directly dispense microencapsulated products into final containers reducing production cost tremendously. No collection fluid or hardening bath are involved eliminating extra processes like filtration, washing and drying which add up to the manufacturing time and cost. High pressures and temperatures are not needed as in the case of state of the art processes such as spray drying/cooling.

Accordingly, the present invention provides an apparatus and method for producing accurately tunable and repeatable capsule sizes from 0.1 to 1,000 microns with narrow size distributions. The methods allow control over the morphology of the capsules with minimal use of encapsulant material and larger active ingredient loading. Yield losses and the coalescence of particles are minimized by charging the generated particles and the walls of the flow channel improving efficiency and reducing manufacturing costs.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for microencapsulating liquids, solids or gases within a shell, comprising:
a housing;
said housing having an interior chamber configured for receiving a laminar flow of a fluid through said chamber;
an ultrasonic generator coupled to said housing, said generator having a vibrating surface disposed within the interior of said chamber and at an angle to the direction of flow of said fluid through said interior chamber;
a source of an encapsulant and a core substrate configured to provide said encapsulant and core substrate to said vibrating surface of said ultrasonic generator; and
means for curing microcapsules produced by said ultrasonic generator.

2. An apparatus as recited in claim 1, further comprising:
means for electrostatically charging said microcapsules and interior walls of said interior chamber.

3. An apparatus as recited in claim 1, further comprising:
a collector adjacent to an opening in said housing;
wherein cured microcapsules are collected.

4. An apparatus as recited in claim 1, wherein said source of encapsulant and core substrate comprises:
one or more reservoirs of liquid encapsulant;
one or more reservoirs of liquid core substrates; and
a plurality of metered tubes;
wherein liquids from said reservoirs are continuously disposed upon the vibrating surface of said ultrasonic generator in controlled amounts.

5. An apparatus as recited in claim 1, wherein liquids from said reservoirs are periodically disposed upon the vibrating surface of said ultrasonic generator in controlled amounts.

6. An apparatus as recited in claim 1, wherein said means for curing comprises a source of ultraviolet light.

7. An apparatus as recited in claim 1, further comprising:
a source of infrared light.

8. An apparatus as recited in claim 6, further comprising:
an ultraviolet exposure chamber coupled to said housing;
wherein ultraviolet light from said source of ultraviolet light is concentrated and directed into said interior of said chamber.

9. An apparatus as recited in claim 1, wherein said ultrasonic generator comprises a multi fluid ultrasonic nozzle having an outer gas flow jacket.

10. An apparatus for producing microcapsules, comprising:
a tubular housing;
said housing having an interior configured for receiving a laminar flow of a gas through the interior of said tubular housing;
means for atomizing fluids coupled to said housing oriented at an angle to the direction of laminar flow of said gas through the interior of said tubular housing; and
means for curing microcapsules;
wherein microcapsules formed from said atomized fluids are entrained in said laminar gas flow.

11. An apparatus as recited in claim 10, wherein said means for atomizing liquids comprises a multi fluid ultrasonic nozzle with an outer gas flow jacket.

12. An apparatus as recited in claim 10, wherein said means for atomizing liquids comprises a multiple layer liquid film disposed on a vibrating surface of an ultrasonic generator.

13. An apparatus as recited in claim 10, wherein said means for atomizing liquids comprises a liquid dispenser configured to drop liquids on a vibrating surface of an ultrasonic generator.

14. An apparatus as recited in claim 10, wherein said source of laminar gas flow comprises a fan.

15. An apparatus as recited in claim 10, wherein said means for curing comprises a source of ultraviolet light.

16. An apparatus as recited in claim 10, further comprising:
a source of infrared light.

17. An apparatus as recited in claim 10, further comprising:
a collector adjacent to an opening in said tubular housing.

18. An apparatus as recited in claim 10, further comprising:
means for electrostatically charging said microcapsules and interior walls of said tubular housing.

19. An apparatus as recited in claim 10, further comprising:
a plurality of means for atomizing fluids operably coupled to said tubular housing.

20. A method for manufacturing microcapsules, comprising:
atomizing a mixture of an uncured shell composition and a substrate using ultrasonic waves within a fluid flow that is at an angle to said ultrasonic waves to produce microcapsules; and
curing said microcapsules within said fluid flow.

21. A method as recited in claim 20, wherein said mixture comprises a light curable polymer and a liquid substrate.

22. A method as recited in claim 21, said mixture further comprising:
a surfactant.

23. A method as recited in claim 20, further comprising:
drying said substrate of said microcapsules prior to said curing step.

24. A method as recited in claim 10, wherein said curing step comprises: exposing said microcapsules to ultraviolet light.

25. A method as recited in claim 20, wherein said curing step comprises: exposing said microcapsules to ultraviolet light and infrared light.

26. A method as recited in claim 20, further comprising:
manipulating the atomization conditions to control the physical characteristics of said produced microcapsules.

27. A method as recited in claim 20, further comprising: charging the outer shell of said produced microcapsules prior to curing.

28. A method as recited in claim 20, further comprising: coating said cured capsules with a coating selected from the group of coatings consisting essentially of a carbohydrate, a surfactant and a polymer shell.

29. A method as recited in claim 20, wherein said substrate is selected from the group of substrates consisting essentially of a single phase fluid, a multiphase fluid, an emulsion, solid suspension or colloidal gas aphrons.

30. A method as recited in claim 20, further comprising:
functionalizing the outer shell of said cured capsules with exposure to reactants entrained within said fluid flow.

31. A method as recited in claim 20, further comprising:
depositing said cured microcapsules directly into containers from said fluid flow.
